(19) United States
(12) Patent Application Publication
(10) Pub. No.: US 2020/0240526 A1
(43) Pub. Date: Jul. 30, 2020

(54) SHUT-OFF ELEMENT OF A HYDRANT, HYDRANT AND MAIN VALVE SEAT

(71) Applicant: VONROLL INFRATEC (INVESTMENT) AG, Zug (CH)

(72) Inventor: Sascha WENGER, Oensingen (CH)

(73) Assignee: VONROLL INFRATEC (INVESTMENT) AG, Zug (CH)

(21) Appl. No.: 16/756,052

(22) PCT Filed: Sep. 25, 2018
(86) PCT No.: PCT/EP2018/076004

§ 371 Date: Apr. 14, 2020

(30) Foreign Application Priority Data
Oct. 16, 2017 (EP) 17196634.4

(51) Int. Cl. F16K 1/54; E03B 9/02; F16K 1/42; F16K 47/08

(52) U.S. Cl. CPC F16K 1/54; E03B 9/02; E03B 2009/022; F16K 47/08; F16K 1/42

(57) ABSTRACT

The shut-off element of a hydrant has a main valve body and a sealing surface that can be brought into mutual sealing contact, of which the sealing surface at least in sections is provided with a recess on the inner circumference.

The present invention relates to a shut-off element of a hydrant, a hydrant and a main valve seat.

Hydrants are connected to a water distribution system and represent a fitting for drawing off water, thus enabling the fire brigade as well as public and private users to draw water from the water distribution system. The network pressure in the water distribution system is typically approx. 6-9 bar. Hydrants comprise a riser pipe with an interior and an exterior, with the water distribution system typically connected to the interior via a floor-side inlet pipe. Water is drawn from the interior via side connections.

For opening and closing hydrants, shut-off elements are known, which can be located in the area of or near the inlet pipe. Shut-off elements are e.g. hydrant main valves, which comprise an axially adjustable main valve body, which can be sealingly closed with a sealing surface of the hydrant. Alternatively, the main valve body can be sealed with a sealing surface of a main valve seat which can be removably introduced into the hydrant. The main valve body is a sealing element which, in a closed position, seals with the sealing surface of the hydrant or main valve seat and, in an open position, releases a connection between the floor-side inlet pipe and the interior of the riser pipe. In this case, the main valve body can be coupled to a valve rod, which allows the main valve body to be adjusted from the closed position to the open position and vice versa. The valve rod is usually arranged axially in the riser pipe of the hydrant and can be adjusted manually via an actuating element, e.g. a spindle drive. In this case, a manual rotation can be converted into an axial adjustment by means of the actuating element, by means of which the valve rod and the main valve body coupled to it can be moved up and down axially.

A problem in the prior art is that pressure surges can occur in the water distribution system when the hydrant is closed. The intensity of a pressure surge increases as the shut-off element closes increasingly quickly. Due to the problem of pressure surges, pipe bursts can occur in the water distribution system, which can have serious consequences. In addition to the problem of high water loss in the water distribution system and the decreasing water pressure, there are also problems of drinking water pollution and damages to land or roads. High pressure surges can also result in the bursting of a fire hose, for example. The pressure surges can also cause water to be forced out of the hose and back into the water distribution system, which can lead to dirty water and/or fire-fighting foam entering the drinking water. It should be noted that the pressure surges can also occur when the hydrant is opened.

In order to solve the problem, it is known in the prior art that the shut-off element of the hydrant should be slowly closed or slowly opened. For this purpose, the prior art suggests, for example, that when closing the hydrant, especially the last turns or rather the last turn to close the shut-off element should be done slowly, as the greatest change in the water quantity occurs when the valve is almost closed. The above also applies when opening the hydrant. One problem with this solution, however, is that this measure can be forgotten, e.g. in the event of an urgent fire-fighting operation, or it may not have been known at all, e.g. due to insufficient instruction of the operator. Thus, pressure surges can occur when operated by untrained personnel. It is therefore an object of the present invention to propose a shut-off element which does not cause pressure surges. It is also object of the present invention to propose a hydrant with such a shut-off element as well as a main valve seat for such a shut-off element.

The aforementioned object is solved by a shut-off element according to independent claim 1, a hydrant according to independent claim 13, and a main valve seat according to independent claim 17. Further advantageous features arise from the dependent claims.

In accordance with the invention, the above-mentioned object is solved by a shut-off element of a hydrant, wherein the shut-off element comprises a main valve body and a sealing surface which can be brought into mutual sealing contact or rather engagement, wherein the sealing surface is provided on the inner circumference thereof at least in sections with a recess which is inscribed or rather introduced into the sealing surface at a variable depth. The shut-off element according to the invention comprises a sealing surface which is provided with a recess which is inscribed into the sealing surface with a variable depth in an inner surface section of the sealing surface or an inner peripheral section of the sealing surface. As soon as the main valve body is moved from e.g. an open position to a closed position of the hydrant, the main valve body passes over such section of the sealing surface, which is provided with the recess entered. In the sector of this adjustment of the main valve body in relation to the sealing surface, the water then flows with a reduced volume via the total cross-sectional area still opening via the recess into e.g. the riser pipe of the hydrant. Due to the shape of the recess, this total opening cross-sectional area can be steadily reduced as the main valve body is moved further towards the closed position, which also steadily reduces the volume of water flowing through. As the main valve body is progressively moved towards the closed position, the main valve body finally comes into complete contact or rather engagement with a section which is not provided with the recess. In this position the shut-off element is completely closed.

The transition of the main valve body from the open position to the closed position along the sealing surface in the course of passing over the section with the inscribed recess can be defined as soft closing, as the shut-off element does not close abruptly in this case, as is the case in the prior art. In the prior art, on the other hand, shortly before reaching the closed position, a circumferentially opening slot between a section of the main valve body and the sealing surface, through which slot the water flows, e.g. into the riser pipe, is abruptly closed if the main valve body is moved even slightly axially in the direction of the closed position (also referred to as the rotation of an actuating element for closing a hydrant), resulting in the disadvantageous pressure surges. Contrary to the prior art, however, the present invention allows the hydrant to be closed gently, even by untrained personnel, without pressure surges occurring. The same advantages of the present invention also apply when the hydrant is opened.

In a preferred embodiment of the shut-off element, the recess is formed in a section of the sealing surface which can be traversed by the main valve body to open and close the shut-off element. The section of the sealing surface provided with the recess can be described as the section for smooth closing or opening of the shut-off element. After the main valve body has traversed this section with the recess, the main valve body comes into complete circumferential contact or rather engagement with a section which is not provided with a recess, and thus seals reliably.

As described above, the recess is inscribed or rather introduced into the sealing surface at a variable depth. In one example, the depth at which the recess is inscribed into the sealing surface (in relation to the axial alignment of the cylindrical sealing surface) may decrease in the direction of the closing position of the shut-off element. The recess can, when viewed in this direction towards the closed position, change in a step-free manner or rather continuously into a section configured without a recess. The recess can be inscribed in a differently deep manner into the sealing surface when viewed in the radial direction (starting from the center axis of the cylindrical sealing surface). In other words, a section of the recess, which is inscribed into the sealing surface at a variable depth, can be defined as a respective cross-sectional area through which water flows—also related as an opening cross-sectional area—when considering a respective axial displacement of the main valve body (in relation to the axis of the sealing surface). The respectively opening cross-sectional area can thus be defined in relation to the axial displacement of the main valve body. As the main valve body is moved progressively in the direction of the closed position, the opening cross-sectional area that opens up decreases progressively and finally assumes the value zero. Due to the variable depth of the recess, smooth closing and opening can also be achieved, thus preventing pressure surges. The depth of the recess can be entered into the sealing surface with a linear or non-linear variation.

In a preferred embodiment of the shut-off element, the recess on the inner circumference of the sealing surface is designed as a continuous recess. The profile of the recess can be continuous or uninterrupted. Such a recess can allow a reduced effort for manufacturing. This can reduce manufacturing costs.

In an alternative embodiment of the shut-off element, the recess on the inner circumference of the sealing surface comprises several partial recesses. Thus, a finer dosage of the water flowing through the partial recesses (and thus through the recess as a whole) can be achieved. It should be mentioned that the word “recess” can mean a cohesive or rather continuous recess, as well as a recess with interruptions (several separate recesses), here referred to as partial recesses. In a preferred embodiment of the shut-off element, the partial recesses are evenly spaced circumferentially.

In a preferred embodiment of the shut-off element, the recess extends along the axial direction of the sealing surface to varying degrees. As mentioned above, the recess can comprise several partial recesses. Thus, for example, at least one of the partial recesses may extend further along the axial direction of the sealing surface than at least one other of the partial recesses. When the shut-off element is closed, water still flows through the at least one partial recess, which extends further into the sealing surface, whereas the water supply is already shut off at the at least one further partial recess. This allows a further fine dosing of the water volume flowing through.

In a preferred embodiment of the shut-off element, the recess on the inner circumference of the sealing surface is curved. In one example, the sealing surface may be provided with several partial recesses in the form of arcs. In another example, the profile of the recess can follow an arc-shaped course, also known as a wave-shaped course. When the shut-off element is opened and closed, the wave-shaped course opens up a cross-sectional area through which the water flows, which cross-sectional area varies from area to area. The variable cross-sectional area can be in relation to the adjustment of the main valve body. This allows the volume of water flowing through to be gently reduced until the shut-off element is completely closed, thus reducing the risk of pressure surges. The volume of water flowing through can also be gently increased when the shut-off element is opened, which also reduces the risk of pressure surges. In one example, the arc-shaped recess can follow a function of a sinusoidal curve, at least in sections. In one example, the arc-shaped recess may have two half arcs which are opposite each other in the same orientation. In this example, the two arcs can extend to different lengths along the axial direction of the sealing surface or rather can have different peaks. When the shut-off element is closed, water still flows through the half-arc with the widest extension, while the water supply through the other, opposite half-arc is already shut off. This allows a further fine dosing of the water volume flowing through.

In one embodiment of the shut-off element, the recess on the inner circumference of the sealing surface has straight sections. In one embodiment of the shut-off element, the recess is formed in a wedge-shaped, triangular, trapezoidal and/or sawtooth-shaped manner. Where appropriate, other geometric shapes are possible. In one example, partial recesses with straight sections may extend to different extents in the axial direction of the sealing surface. When the shut-off element is closed, water still flows through at least one of the partial recesses, e.g. triangular or wedge-shaped partial recesses, respectively, which extends further than at least one other partial recess over which the water supply is already shut off. In this way, a further fine dosing of the water volume flowing through can be achieved.

In a preferred embodiment of the shut-off element, the sealing surface is configured to be formed integrally with a hydrant body of a hydrant. The sealing surface can be formed integrally with the material of the hydrant, e.g. when casting a component of the hydrant. In one embodiment of the shut-off element, the sealing surface is configured to be formed integrally with a riser pipe of the hydrant. Costs can be saved by integrally forming the sealing surface in the course of the production of the riser pipe of the hydrant, e.g. when casting the riser pipe.

In an alternative embodiment, the shut-off element also includes a main valve seat, the inner surface of which is configured as the sealing surface. The main valve seat can be a component that can be removably inserted into the shut-off element, e.g. a main valve section of a hydrant. The inner surface of the main valve seat, or rather its sealing surface, is provided with the recess described above.

The invention also relates to a hydrant comprising a shut-off element having a main valve body and a sealing surface which can be brought into mutual sealing contact, wherein the sealing surface is provided on the inner circumference thereof at least in sections with a recess which is inscribed into the sealing surface at a variable depth. Thus, a hydrant is created which can be opened and closed gently, whereby disadvantageous pressure surges are eliminated.

In one embodiment of the hydrant, the sealing surface and the hydrant body are formed integrally. In this configuration, a section, or rather component, of the hydrant is formed as the sealing surface itself. In an embodiment, the hydrant comprises a riser pipe, wherein the sealing surface and the riser pipe are formed integrally. In this configuration, a section of the riser pipe is designed as the sealing surface itself. The above configurations allow cost savings. For example, the sealing surface is formed to the riser pipe while casting thereof.

In an alternative embodiment, the hydrant also includes a main valve seat, the inner surface of which is configured as the sealing surface. The inner surface of the main valve seat is provided with the recess described above. The main valve seat can advantageously be replaced, for example, due to wear or altered requirements. This makes the hydrant according to the invention particularly easy to maintain and at the same time has the property that it can be opened and closed without pressure surges.

The invention is also directed at a main valve seat for a hydrant, wherein the main valve seat is removably insertable into a section of a shut-off element of the hydrant in such a way that the main valve seat and a main valve body enclosed in the hydrant can be brought into mutual sealing contact, wherein the main valve seat has a sealing surface on the inner circumference thereof, which is provided at least in sections with a recess which is inscribed into the sealing surface with a variable depth. Thus, a main valve seat is created which can be easily replaced, for example as a result of wear. The main valve seat according to the invention allows a hydrant equipped with this main valve seat to be opened and closed by untrained personnel, for example, without pressure surges occurring.

It is expressly pointed out that the above embodiment variants can be combined in any way. Only those combinations of embodiments are excluded which would lead to contradictions due to the combination.

In the following, the present invention is explained in closer detail by means of exemplary embodiments shown in drawings, wherein:

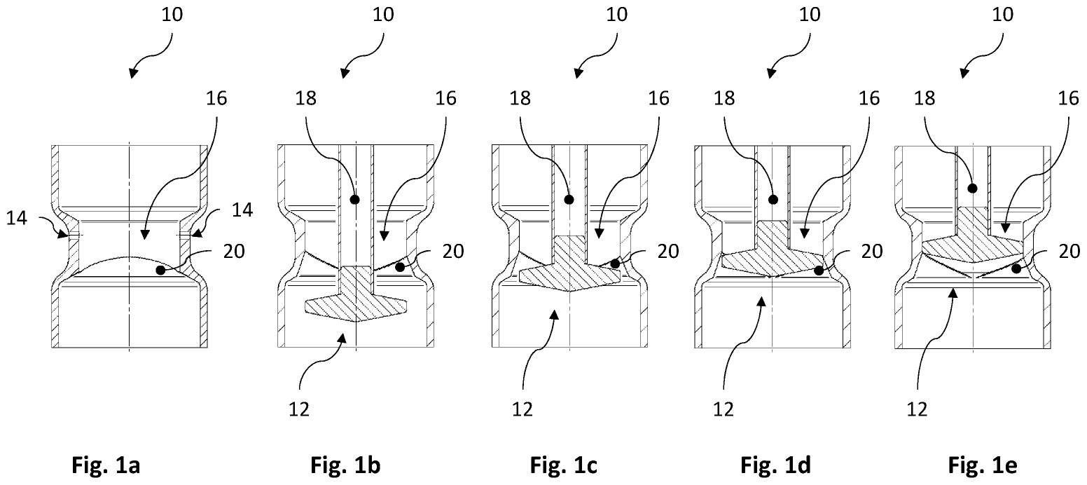

FIGS. 1a-e show several sectional views of a shut-off element of a hydrant in a first embodiment;

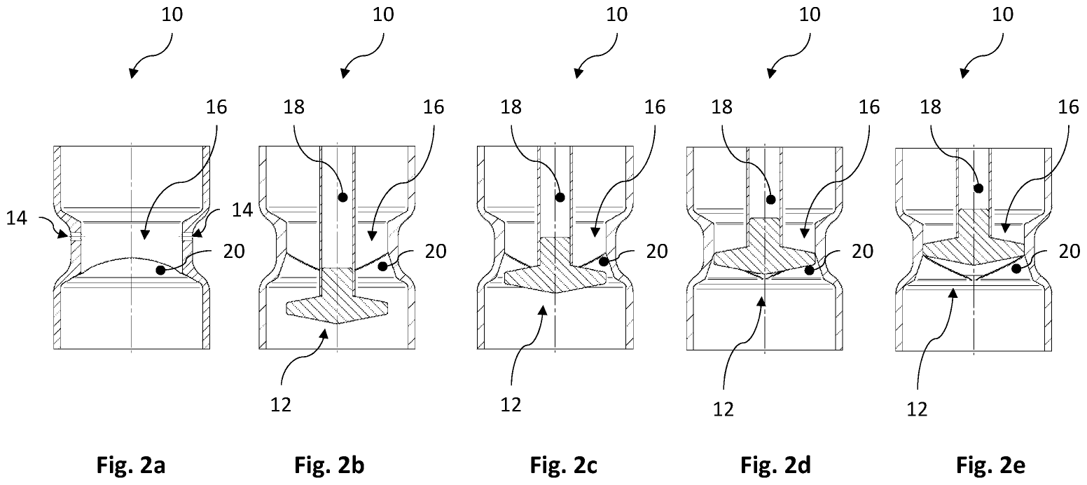

FIGS. 2a-e show several sectional views of a shut-off element of a hydrant in a second embodiment;

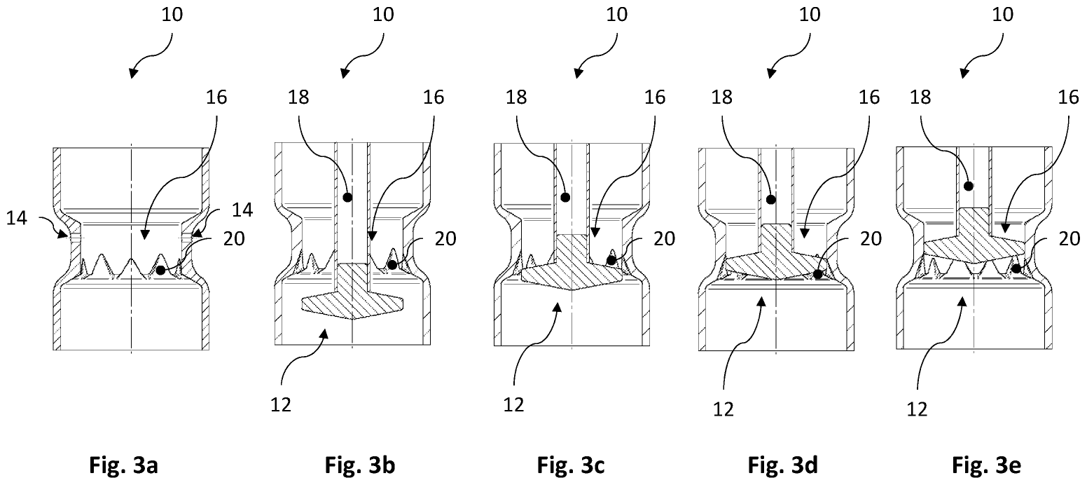

FIGS. 3a-e show several sectional views of a shut-off element of a hydrant in a third embodiment;

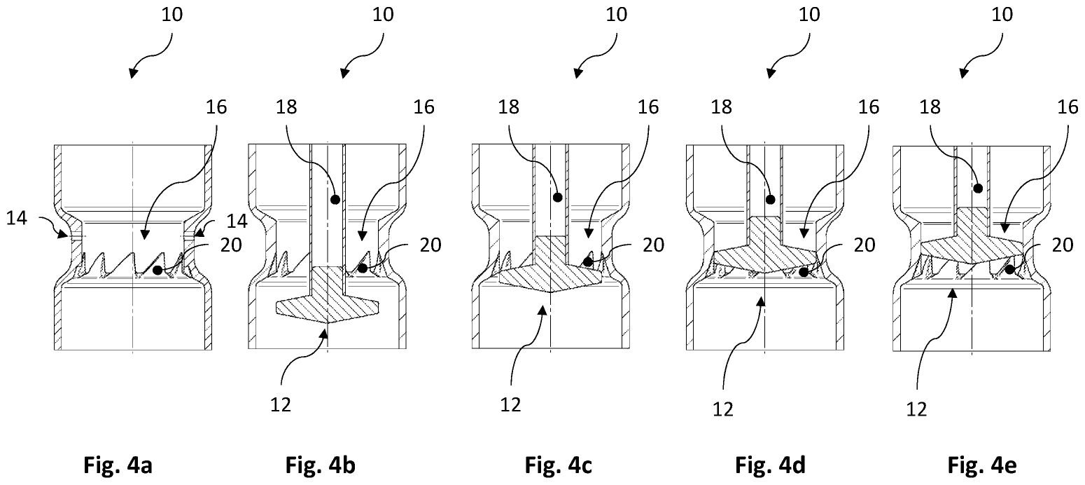

FIGS. 4a-e show several sectional views of a shut-off element of a hydrant in a fourth embodiment;

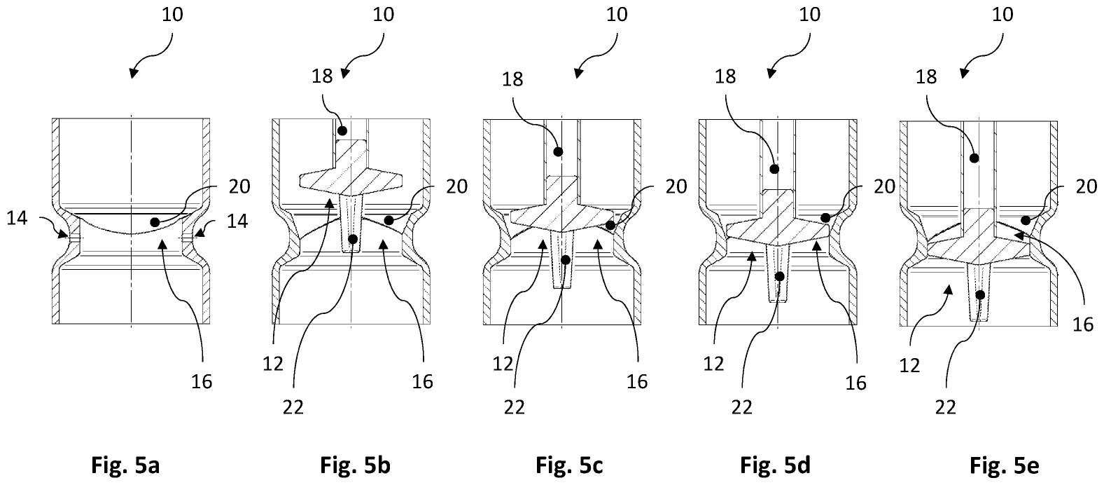

FIGS. 5a-e show several sectional views of a shut-off element of a hydrant in a fifth embodiment;

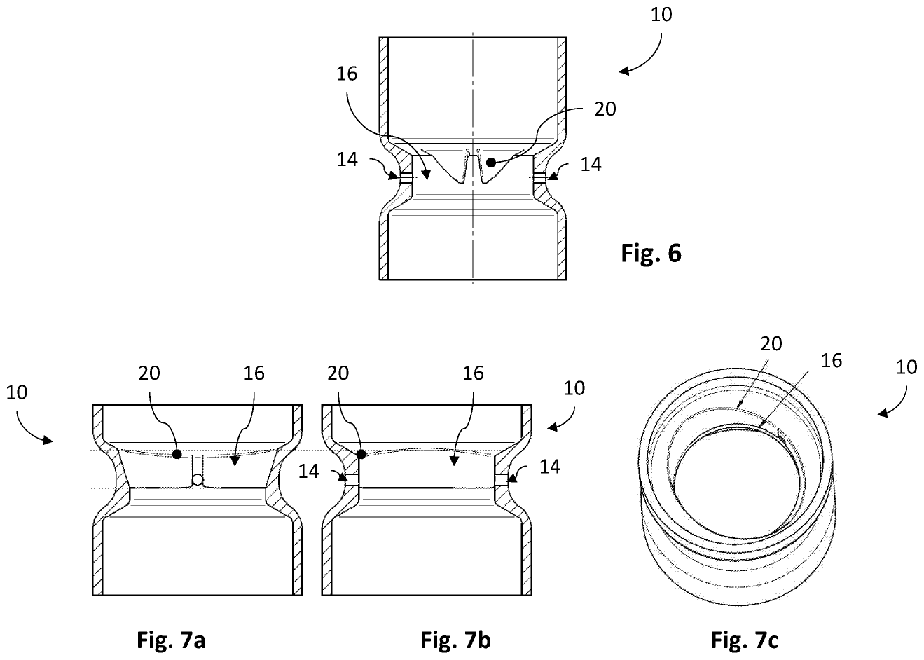

FIG. 6 shows a sectional view of a shut-off element of a hydrant in a sixth embodiment; and

FIGS. 7a-c show a sectional view of a shut-off element of a hydrant in a seventh embodiment.

FIGS. 1 to 5 show examples of five embodiments of a shut-off element 10 according to the invention in five views, respectively. The figures marked with “FIG. a)”, i.e. FIGS. 1a, 2a, . . . , 5a, each show a view of the shut-off elements 10 of a respective embodiment without a main valve body in order to obtain a clear view. The other figures, i.e. “FIGS. b)-e)”, show the shut-off elements 10 of a respective embodiment in respective different positions of a main valve body 12. It should be noted that the respective “FIG. a)” show the shut-off element 10 in a sectional view along a central axis of two opposite drainage holes 14, while “FIGS. b)-e)” each show a sectional view rotated by 90°.

The shut-off element 10 comprises a sealing surface 16, wherein the main valve body 12 and the sealing surface 16 can be brought into mutually sealing contact or rather engagement. In other words, the main valve body 12 can be adjusted such that it seals circumferentially with the sealing surface 16. The “FIGS. b)-e)” show the shut-off element 10 starting from an open position (“FIG. b)” in each case: shut-off element completely open) via two intermediate positions (“FIGS. c,d)” in each case) (explained in more detail in the following embodiments) up to a closed position (in each case “FIG. e)”: shut-off element completely closed).

The embodiments shown in FIGS. 1-4 relate to a shut-off element 10 which is closed in the direction of water flow (in said FIGS. 1-4 in the direction from bottom to top), while the embodiments shown in FIGS. 5-7 each relate to a shut-off element 10 which is closed against the direction of water flow (in said FIGS. 5-7 in the direction from top to bottom). The main valve body 12 is moved axially by a valve rod 18 into the closed position (here e.g. in the direction upwards in the aforementioned FIGS. 1-4) or into the open position (here e.g. in the direction downwards in the aforementioned FIGS. 1-4). Although not shown in the embodiments shown in FIGS. 1-4, the main valve body 12 may be provided with vanes (e.g. two opposite vanes) which rest against the sealing surface 16 to reliably guide the main valve body 12 axially along the center axis. In the above-mentioned embodiments, in which the shut-off element 10 is closed in the direction of water flow, the vanes can extend upwards in relation to the main valve body 12 in order to reliably come into contact or rather engagement with the sealing surface 16.

In the case of the shut-off elements 10 shown in each case, the sealing surface 16 is provided on the inner circumference of a constricted section of the shut-off element 10 itself. In other words, an inner surface section of the shut-off element 10 itself forms the sealing surface 16. The shut-off element 10 can be part of a hydrant, e.g. a riser pipe. Although not shown, alternatively a replaceable main valve seat can be provided, the inner circumferential surface of which is provided with the sealing surface. The main valve seat can be inserted into the hydrant, e.g. into the riser pipe. It should be mentioned that the term “inner circumference of the sealing surface” means the inner surface or inner circumferential surface of the sealing surface itself.

The respective sealing surfaces 16 are provided in sections with a recess 20, via which the water can continue to flow in the intermediate position of the main valve body 12. This will be discussed in more detail below when considering the individual embodiments.

In the following, the individual embodiments are discussed separately. Throughout the drawings, identical or equivalent components or shaped portions are assigned the same reference numerals.

The sealing surface 16 shown in the embodiment of FIGS. 1a-e is provided with a recess 20 or rather shaped portion which may be wedge-shaped. In the embodiment shown, the recess 20 is formed e.g. by two wedges or a wedge-shaped recess. The wedge-shaped recess can be recessed throughout. Alternatively, wedge-shaped recesses or rather shaped portions are interrupted by sections of the sealing surface and can thus form two partial recesses. Irrespective of whether several “interrupted” partial recesses are present or not, the term “recess” is uniformly used herein.

The wedge-shaped recess 20 is formed in a section of the sealing surface 16, which is traversed by the main valve body 12 when the shut-off element 10 closes (see FIGS. 1c,d), wherein the main valve body 12 then comes to rest in a further section of the sealing surface 16. In this further section, the main valve body 12 comes to rest fully circumferentially against the sealing surface 16 (see FIG. 1e: closed position). While the main valve body 12 passes over or rather traverses the section of the sealing surface 16 provided with the wedge-shaped recess 20, the water flows via an overall variable cross-sectional area, which is opened between the circumference of the main valve body 12 and the wedge-shaped recess 20. Due to the shape of the wedge-shaped recess 20, this cross-sectional area decreases further as the main valve body 12 is moved towards the closed position. Thus, the volume of water flowing through is also steadily reduced. FIG. 1c shows the shut-off element 10 in an open state, with the main valve body 12 already in the area of influence of the recess 20 of the sealing surface 16, also known as the “soft closing” geometry.

In the shown embodiment, a wedge of the wedge-shaped recess 20 also extends further into the sealing surface 16 as compared to the opposite wedge, or rather the two wedges have different high points or rather peaks. In other words, the two wedges extend differently far into the sealing surface 16. As a result, water continues to flow via the further extending wedge even when the opposite wedge is already completely shut off by the main valve body 12. Therefore, in FIG. 1d the shut-off element 10 is shown in a partially closed state, wherein, in this state, the water flows only one sided or rather unilateral (in FIG. 1d via the wedge on the left side), resulting in a gently closing geometry or rather configuration during the last turns or rather during the last turn for closing the shut-off element 10. The wedge-shaped recess 20 allows a further fine dosing of the water flow during the last turns or rather during the last turn for closing the shut-off element 10.

The invention allows the volume of water passing through the recess 20 to steadily decrease in a certain ratio during the last turns or rather during the last turn to close the shut-off element 10, and not to be shut off abruptly as is the case in the prior art. The present invention thus effectively prevents the occurrence of pressure surges, even if the hydrant is operated by untrained personnel, for example.

FIGS. 2a-e show a second embodiment of the shut-off element 10 according to the invention. In this embodiment, the recess 20, which is inscribed into the sealing surface 16, is also wedge-shaped. In contrast to the embodiment shown in FIGS. 1a-e, the opposite wedges of the recess 20 extend the same distance. As a result, the shut-off element 10 is essentially closed simultaneously via the opposite wedges.

FIGS. 3a-e show a third embodiment of the shut-off element 10 according to the invention. In this embodiment, the recess 20 is configured by several partial recesses, which are wedge-shaped or triangular in shape with symmetric draft angles. In this embodiment the partial recesses can extend in relation to each other to different extents into the sealing surface 16. In an example, adjacent partial recesses extend differently far into the sealing surface 16, respectively, wherein each partial recess can extend substantially the same distance into the sealing surface 16 as the respective next but one partial recess. Of course, any combination of extensions into the sealing surface 16 is possible. It may also be possible that all partial recesses extend differently into sealing surface 16 in relation to each other. As shown in FIG. 3, a total of ten wedge-shaped partial recesses can be provided by way of example along the inner circumferential surface of the sealing surface 16 (for illustrative reasons, only five wedge-shaped partial recesses are shown in FIG. 3a). These partial recesses extend, starting from their base, from the lower end of the sealing surface 16, or rather from the water inlet, into the sealing surface 16, wherein they taper continuously and end or rather terminate with their tips. The tips of the partial recesses can merge smoothly or without steps into that section of the sealing surface 16 which has no recess. The tips of the partial recesses end, for example, in a section of the sealing surface 16 which makes up half or slightly less than half of the total extension of the sealing surface 16. In this way it can be ensured, for example, that the main valve body 12 comes into reliable mutual contact or rather engagement with such section of the sealing surface 16 which has no recess, and that the shut-off element 10 is thus reliably sealed.

With the position of the main valve body 12 in relation to the sealing surface 16 as shown in FIG. 3c, the main valve body 12 is within the area of influence of the soft-closing seat geometry. In this position, the water flows through the total opening cross-sectional area of all wedge-shaped partial recesses. In FIG. 3d, the main valve body 12 has traversed the partial recesses to such an extent that the water flows only via the tips of those partial recesses which extend further into the sealing surface 16. In the shown example, the water flows via the tips of every second partial recess, which extend essentially equally far into the sealing surface 16. In other words, the water flows via the tip of each of the partial recesses, respectively, which are separated from each other by a partial recess. It is understood that partial recesses which extend substantially equally far into the sealing surface 16 may also be separated by two or more partial recesses. Further examples are possible which indicate how partial recesses with essentially the same extensions into the sealing surface 16 can be combined. For example, all partial recesses can also extend differently far into the sealing surface 16 in relation to each other. Following the example above with a total of ten triangular shaped partial recesses, the water thus flows only via the opening cross-sectional area at the tips of five wedge-shaped partial recesses. The shut-off element 10 thus allows a further fine dosing of the water flow during the last turns or during the last turn to close the shut-off element 10.

FIGS. 4a-e show a fourth embodiment of the shut-off element 10 according to the invention. In this embodiment, recess 20 is configured by several partial recesses, which are in this case wedge-shaped with asymmetrical or sawtooth-shaped draft angles. In this embodiment, all partial recesses extend equally far into the sealing surface 16. For example, also in this case, a total of ten sawtooth-shaped partial recesses can be provided along the inner circumferential surface of the sealing surface 16, which, starting with their base, extend from the lower end of the sealing surface 16, or rather from the water inlet side, so far into the sealing surface 16 that the tips of the partial recesses end in a section of the sealing surface 16 which makes up a little less than half of the total extension of the sealing surface 16.

In the position of the main valve body 12 as shown in FIG. 4c, the main valve body 12 is within the area of influence of the soft-closing seat geometry. In this position, the water flows through the total opening cross-sectional area of all sawtooth-shaped partial recesses. In FIG. 4d the main valve body 12 has traversed the sealing surface 16 to such an extent that all partial recesses are closed at the same time. The sawtooth-shaped draft angles allow a further fine dosing of the water flow during the last turns or during the last turn to close the shut-off element 10.

FIGS. 5a-e show a fifth embodiment of the inventive shut-off element 10. In this embodiment, the shut-off element 10 is designed to close against the direction of water flow (in the figures from top to bottom). The main valve body 12 is provided with two vanes 22 (only one vane 22 can be seen in the figures), which are supported on the sealing surface 16 in order to reliably guide the main valve body 12 axially along the central axis. In this embodiment, the sealing surface 16 is also provided with a recess 20, which is configured here by two wedge-shaped partial recesses with symmetrical draft angles. The two wedge-shaped partial recesses extend to different extents into the sealing surface 16, such that the shut-off element 10 closes offset (see also the description relating to FIGS. 1a-e).

In the position of the main valve body 12 as shown in FIG. 5c, the main valve body 12 is within the area of influence of the soft-closing seat geometry. In this position, the water flows through the total opening cross-sectional area of the two wedge-shaped partial recesses. In FIG. 5d, the main valve body 12 has traversed the sealing surface 16 to such an extent that the water flows only via the remaining cross-sectional area of said wedge-shaped partial recess (the left partial recess in the figure), which extends further into the sealing surface 16 than the other partial recess. In FIG. 5e, the main valve body 12 is adjusted so far that it comes to rest completely in circumferential sealing with the sealing surface 16 and the shut-off element 10 is thus completely closed. Due to the design of the sealing surface 16 having the described wedge-shaped partial recesses with asymmetrical draft angles, a further fine dosing of the water flow during the last turns or during the last turn to close the shut-off element 10 is possible.

FIG. 6 shows a sectional view of a shut-off element 10 of a hydrant in a sixth embodiment. In this embodiment, the shut-off element 10 is also configured in such a way that it is closed against the water flow. For illustrative reasons, the main valve body is omitted. The sealing surface 16 has a recess 20 comprising four wedge-shaped partial recesses (for illustrative reasons only two wedge-shaped partial recesses are shown) with asymmetrical and mirror-inverted draft angles. The wedge-shaped partial recesses can have a varying depth, which decreases steadily towards the tips of the wedge-shaped partial recesses and merges into the section of the circumferentially sealing surface or rather runs out essentially smoothly therein. The configuration shown here can be realized in a particularly advantageous and reliable manner.

FIGS. 7a-c show the shut-off element 10 in a seventh embodiment. FIGS. 7a,b show the shut-off element 10 in a sectional view, while FIG. 7c shows the shut-off element 10 in a perspective view. For illustrative reasons the main valve body is omitted. The shut-off element 10 is configured such to close against the water flow. In this embodiment, the opening cross-sectional area of the sealing surface 16 forms a transition from a circular cross-section to a recess 20 with an elliptical cross-section. The elliptical shape of the recess 20 allows the water volume, in a transition area between the circular cross section and the elliptical cross section, to steadily decrease as this transition area is traversed by the main valve body.

1. A shut-off element (10) for use in a hydrant, wherein the shut-off element (10) comprises a main valve body (12) and a sealing surface (16) which can be brought into mutually sealing contact, wherein the sealing surface (16) is provided on the inner circumference thereof, at least in sections, with a recess (20) which is inscribed into the sealing surface (16) with a variable depth.

2. The shut-off element (10) according to claim 1, wherein the recess (20) is formed in a section of the sealing surface (16) which section can be traversed by the main valve body (12) for opening and closing the shut-off element (10).

3. The shut-off element (10) according to claim 1, wherein the recess (20) on the inner circumference of the sealing surface (16) is formed as a continuous recess (20).

4. The shut-off element (10) according to claim 1, wherein the recess (20) on the inner circumference of the sealing surface (16) comprises a plurality of partial recesses.

5. The shut-off element (10) according to claim 4, wherein the partial recesses are evenly spaced from each other circumferentially.

6. The shut-off element (10) according to claim 4, wherein the recess (20) extends to different extents along the axial direction of the sealing surface (16).

7. The shut-off element (10) according to claim 1, wherein the recess (20) on the inner circumference of the sealing surface (16) is of arcuate shape.

8. The shut-off element (10) according to claim 1, wherein the recess (20) on the inner circumference of the sealing surface (16) comprises rectilinear sections.

9. The shut-off element (10) according to claim 8, wherein the recess (20) is formed in a wedge-shaped, triangular, trapezoidal and/or sawtooth-shaped manner.

10. The shut-off element (10) according to claim 1, wherein the sealing surface (16) is configured to be integrally formed with a hydrant body of a hydrant.

11. The shut-off element (10) according to claim 10, wherein the sealing surface (16) is configured to be formed integrally with a riser pipe of the hydrant.

12. The shut-off element (10) according to claim 1, further comprising a main valve seat, the inner surface of which is configured as the sealing surface.

13. A hydrant, comprising a shut-off element (10), which comprises a main valve body (12) and a sealing surface (16), which can be brought into mutual sealing contact, wherein the sealing surface (16) is provided on the inner circumference thereof, at least in sections, with a recess (20), which is inscribed into the sealing surface (16) with a variable depth.

14. The hydrant according to claim 13, wherein the sealing surface (16) and the hydrant body are formed integrally.

15. The hydrant according to claim 13, further comprising a riser pipe, wherein the sealing surface (16) and the riser pipe are formed integrally.

16. The hydrant according to claim 13, further comprising a main valve seat, the inner surface of which is configured as the sealing surface.

17. A main valve seat of a hydrant, wherein the main valve seat is removably insertable into a section of a shut-off element of the hydrant in such a way that the main valve seat and a main valve body comprised by the hydrant are brought into mutual sealing contact, wherein the main valve seat on the inner circumference thereof is provided with a sealing surface, which is provided at least in sections with a recess which is inscribed into the sealing surface (16) with a variable depth.
